(19) United States
(12) Patent Application Publication
(10) Pub. No.: US 2026/0218811 A1
(43) Pub. Date: Jul. 30, 2026

(54) A VALVE WITH A SPRING

(71) Applicant: Valmet Flow Control Oy, Vantaa (FI)

(72) Inventor: Henri HAKULINEN, Vantaa (FI)

(73) Assignee: Valmet Flow Control Oy, Vantaa (FI)

(21) Appl. No.: 19/145,730

(22) PCT Filed: Dec. 22, 2023
(86) PCT No.: PCT/FI2023/050739

§ 371 Date: Jul. 3, 2025

(30) Foreign Application Priority Data
Jan. 5, 2023 (FI) 20235017

(51) Int. Cl. F16K 41/02

(52) U.S. Cl. CPC F16K 41/026

(57) ABSTRACT

This invention relates to a valve (17) including a closure member, a shaft (101) which is connected to the closure member for adjusting a position of the closure member and which has an end (102) protruding to an outside of the valve via a packing cavity (18). The valve (17) also includes a valve packing (103) arranged in 5 the packing cavity (18) to surround the shaft (101), and a spring (1) provided in the packing cavity (18) to contact the valve packing (103). In order to provide an improved sealing performance to the valve packing (103), the spring (1) comprises an upper support surface (2), a lower support surface (3), and at least two segments (4) arranged between the upper (2) and the lower support surface (3), 10 wherein at least one of the segments (4) comprises a spring cell (5).

### BACKGROUND OF THE INVENTION

### Field of the Invention

This invention relates to a valve with a spring.

### Description of Prior Art

In relation to industrial piping systems, significant fluid pressures are often encountered and need to be contained within the systems. Such conditions set high requirements also for the valves used in connection with these piping systems, said valves having to withstand the same pressure conditions with minimized fugitive emissions. An additional challenge is provided by the fluctuating temperatures associated with many industrial processes, wherein the temperature fluctuations may be in the order of several hundred degrees Celsius over relatively short periods of time. Over the recent years, increasingly demanding industrial specifications have been set for the acceptable fugitive emission rates of gases released by the industrial valves, adding further to the requirements set for the tightness of sealing between the valve components, as well as between the valve and the surrounding system. Majority of fugitive emissions in piping systems are usually a result of leakages at rotary shafts or sliding stems of valves.

In conventional shaft sealing constructions for maintaining good tightness despite of thermal cycling, packing relaxation, wear or extrusion, etc., live-loaded packing is used. In the live-loaded packing, packing rings are compressed inside a packing ring cavity by force exerted by stud bolts, usually through a gland (follower) to a high pressure, said pressure typically having a magnitude of tens of megapascals. Between the gland and stud bolt fasteners, pre-tensioned Belleville spring washers are used to supply substantial force required to retain the required packing compression over time. However, due to the uneven force distribution over the length of the packing caused by friction between the packing elements, the sealing performance so achieved is often less than ideal. The sealing performance may also decline over time due to gradual changes in the force distribution and the time-dependent behavior of the packing materials, which in combination with the limited amount of compression length reserve provided by the spring packs may result in reduced performance over time or in varying temperature conditions. It is known from the prior art also to place a spring at the bottom of the packing to provide more even force distribution over the length of the packing. However, the conventional springs do not have sufficient properties to withstand the high compression exerted by the stud bolts and provide sufficient spring force with minimal hysteresis in a relatively small size (height vs. deflection/spring force). A valve sealing arrangement utilizing such a spring system is known from, for example, CN 218094596 U.

### SUMMARY OF THE INVENTION

An object of the present invention is to solve the above-mentioned drawbacks and to provide a solution for improved sealing performance. This object is achieved with a valve according to independent claim 1.

By providing a valve with a spring comprising and upper and a lower support surface and segments arranged between the upper and the lower support surface, the segments comprising a spring cell, it is possible to obtain a structure enabling a tight sealing with low emission rates.

Preferred embodiments of the invention are disclosed in the dependent claims.

### BRIEF DESCRIPTION OF DRAWINGS

In the following the present invention will be described in closer detail by way of example and with reference to the attached drawings, in which

FIG. 1 illustrates a side view of a segment according to a first embodiment of a spring,

FIG. 2 illustrates a second embodiment of the spring as seen diagonally from above,

FIG. 3 illustrates a side view of a third embodiment of the spring,

FIG. 4 illustrates a side view of a fourth embodiment of the spring,

FIG. 5 illustrates a side view of a fifth embodiment of the spring,

FIG. 6 illustrates a side view of a segment according to a sixth embodiment of the spring,

FIG. 7 illustrates a partial cross-cut section of a valve provided with the spring according to any one of the FIGS. 1 to 6, and

FIG. 8 illustrates the valve of FIG. 7 as a whole diagonally from the side.

### DESCRIPTION OF AT LEAST ONE EMBODIMENT

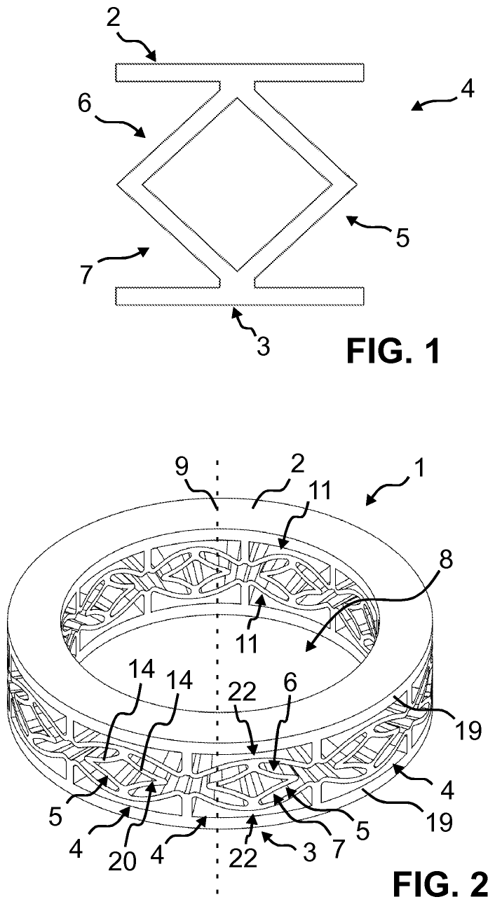

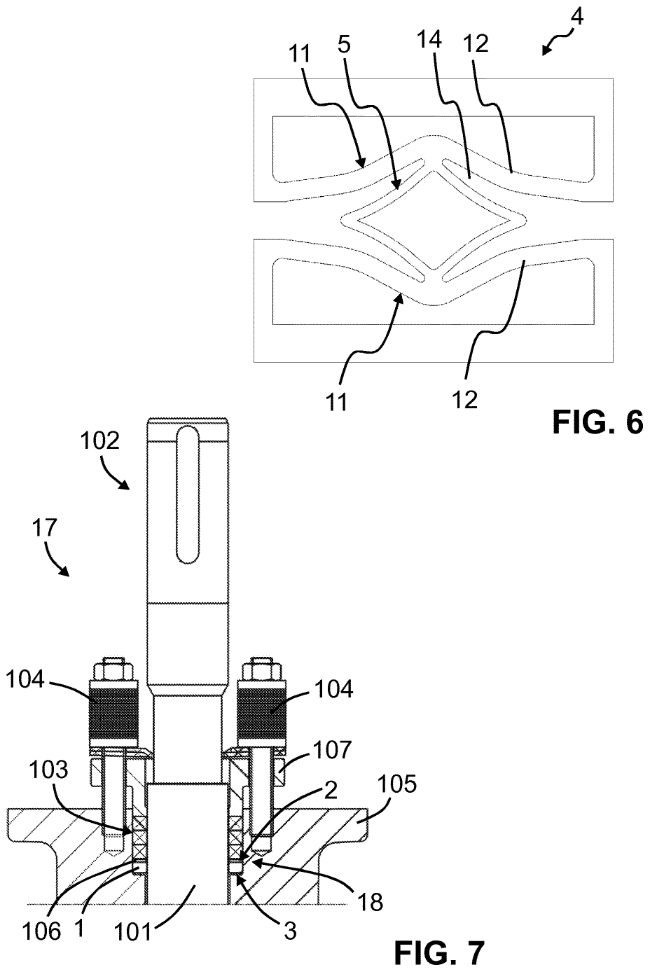

FIG. 1 illustrates a side view of a segment 4 according to a first embodiment of a spring 1. The spring 1 according to said first embodiment comprises an upper support surface 2 and a lower support surface 3, and at least two segments 4 according to the illustration of FIG. 1 arranged between said support surfaces 2, 3. The segments 4 in this context are defined as repeating structural units arranged contiguously to form a uniform structure between the support surfaces 2, 3. To further illustrate this concept, another variation of an individual segment 4 is illustrated in FIG. 6, said variation corresponding to a sixth embodiment of the spring 1. In preferable arrangements of the spring structure, the spring 1 is provided with at least three, more preferably with 8 to 10 segments 4. The number of segments 4 may be adjusted based on, for example, the diameter or the required stiffness of the spring 1. In some embodiments, the segments 4 may also be provided to fill only a part of the volume between the support surfaces 2, 3, such that vacant spaces are left to the structure between at least some of the adjacent segments 4.

FIG. 2 illustrates a second embodiment of the spring 1, as seen in its entity diagonally from above. The spring 1 according to this example comprises segments 4 having the same principal structure as disclosed in relation to FIG. 1, with additional elements added to the structure for further advanced functionality. In the example of FIG. 2, the upper 2 and the lower support surface 3 are arranged parallel to each other and formed on two circular ring formations 19 at the respective upper and lower ends of the spring 1, and define the outer borders of the spring at said ends. In this context, the terms upper and lower refer to the locations of the spring 1 as observed in its installed position. As seen in FIG. 2, the segments 4 between the upper 2 and the lower support surface 3 comprise a spring cell 5, the spring cell 5 having an upper section 6 connecting to the upper support surface 2 and an opposite lower section 7 connecting to the lower support surface 3. In different embodiments of the spring 1, the spring cell 5 is provided to at least one of the segments 4, while some of the segments 4 may also be provided to the spring without the spring cell 5.

In the example of FIG. 2, both of the upper 6 and the lower section 7 of the spring cell 5 comprise two opposite arch segments 14, wherein each arch segment 14 connects to the corresponding arch segment of the opposite cell section at one end, and to the upper 2 and respectively the lower support surface 3 at another end. At the connection points between the arch segments 14 of the opposite cell sections, an angle 20 is formed. In said example, connecting of the spring cells 5 to the support surfaces 2, 3 takes place through the circular ring formations 19 at the respective upper and lower ends of the spring 1.

As a result of said arrangement, the arch segments 14 together form a structure capable of elastically accommodating compression in the up- and downward directions of the spring cell 5 by bending and reorientation of the arch segments 14. As such, the spring cells 5 form an elastic structure to the spring 1, enabling the spring 1 to be elastically compressed in a direction perpendicular to the upper 2 and the lower support surface 3, in other words such that the distance between the support surfaces 2, 3 is reduced. In other embodiments of the spring 1, the structure of the spring cells 5 may also be arranged differently based on, for example, the expected loading conditions or the required stiffness of the spring 1 in the application at hand. For example, the arch segments 14 may also be shaped so as to define a circular shape to the spring cell 5, as opposed to the angular shape illustrated in the example of FIG. 2. In some embodiments of the spring 1, the arch segments 14 may also be provided as substantially straight portions.

The spring 1 in the example of FIG. 2 is arranged to a shape of a ring, in other words such that it comprises a channel 8 extending from the upper support surface 2 to the lower support surface 3 along a middle axis 9 of the spring 1. In said example, the four interconnected arch segments 14 comprised in the spring cells 5 are configured to form a closed loop which is open towards and away from the middle axis 9, in other words so that an opening is formed through the spring cells 5 extending from the channel 8 to the outer perimeter of the spring 1. In said arrangement, the compression of the spring 1 causes the arch segments 14 to bend and reorientate such that the width of the spring cells 5, in other words their extension in the tangential direction of the spring 1, is increased while simultaneously their height, in other words their extension towards the upper 2 and the lower support surface 3, is reduced.

By contrast, in a possible rotated arrangement in which the orientation of the spring cells 5 causes them to extend in the radial direction of the spring 1 under compression, the compression of the spring 1 may be limited by the space available in said radial direction, namely the distance between the channel 8 and the outer perimeter of the spring 1. In the example of FIG. 2, the spring 1 is a cylindrical spring, its outer perimeter across the length of the spring 1 following the perimeter of the two circular ring formations 19 at the upper and lower ends of the spring 1. In other embodiments of the spring 1, the outer perimeter may also be formed such that the diameter or the cross-sectional shape of the spring varies across the length of the spring, so as to accommodate the dimensional or structural requirements set by any specific use case.

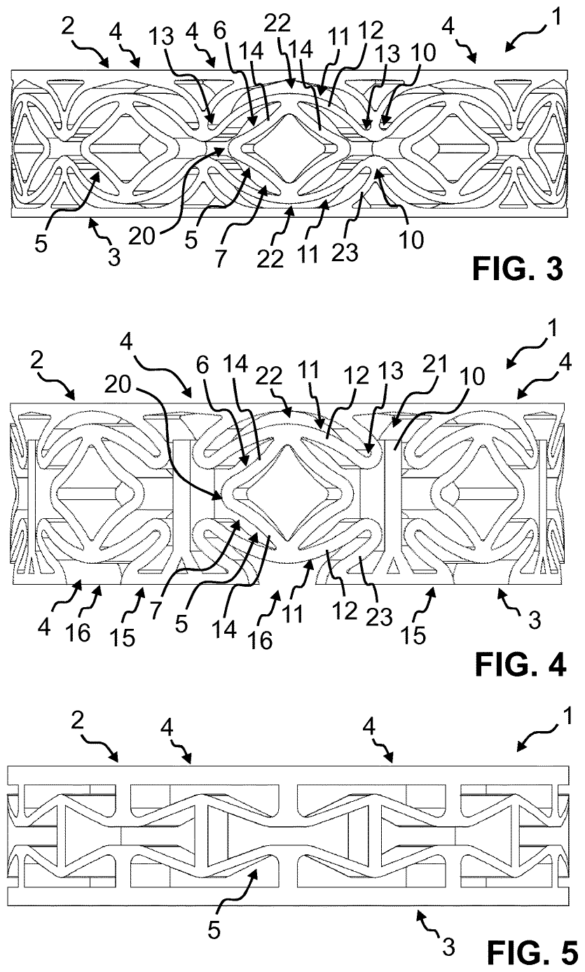

FIG. 3 illustrates a third embodiment of the spring 1, said embodiment sharing most of the structural features illustrated in the example of FIG. 2. In the examples of FIGS. 2 and 3, the spring cells 5 connect to the upper 2 and the lower support surface 3 through a spring arm 11. More precisely, in said examples a spring arm 11 extends between the upper section 6 of the spring cell 5 and the upper support surface 2, and another spring arm 11 extends between the lower section 7 of the spring cell 5 and the lower support surface 3. By the addition of the spring arms 11 as disclosed, an additional elastically compressible element is provided to the spring 1. In other embodiments of the spring 1, the spring arms 11 may be provided only to some of the spring cells 5, or they may be provided, for example, only to the upper 6 or the lower section 7 of the spring cells 5.

In the examples of FIGS. 2 and 3, each spring arm 11 is shaped as an arch 12 curved around the spring cell 5 and connecting at both ends to the upper 2 or the lower support surface 3. In other words, the spring arms 11 are arranged to partly encircle the spring cell 5 at the upper 6 and the lower section 7, simultaneously delimiting a separating gap 22 between the spring cell 5 and the upper 2 and the lower support surface 3 directly above and below the spring cell 5, respectively. With said arrangement, an additional degree of elasticity is provided to the spring 1, wherein the compression of the spring 1 causes the spring arms 11 to deflect by bending and thereby to allow the spring cell 5 to shift closer to the respective support surface 2, 3. However, in some embodiments of the spring 1, the spring arms 11 may also be provided as, for example, sections extending upwards respectively downwards between the spring cell 5 and the support surface 2, 3, in other words such that the spring arms 11 have a substantially vertical orientation. In such case, the spring arms 11 may provide elasticity by, for example, deflecting sideways under compression.

FIG. 4 illustrates a fourth embodiment of the spring 1, as seen directly from the side. The cylindrical spring 1 illustrated in the example of FIG. 4 shares most of the structural features of the second and the third embodiments. In this example, the spring 1 further comprises compression limiters 10 extending from the lower support surface 3 towards the upper support surface 2 a part of the distance between said support surfaces 2, 3. More precisely, the compression limiters 10, which in said example are formed as elongated rods, extend perpendicularly from the lower support surface 3 such that a gap 21 is formed between the free end of each compression limiter 10 and the upper circular ring formation 19 comprising the upper support surface 2. In other embodiments of the spring 1, the number, shape and location of the compression limiters 10 may deviate freely from the example of FIG. 4, such that the compression limiters 10 may also extend from the upper support surface 2 towards the lower support surface 3, mirroring the illustrated arrangement.

With the arrangement of the compression limiters 10 as disclosed, the extent of compression provided by the spring 1, namely the maximum reduction of the distance between the upper 2 and the lower support surface 3, may be adjusted. In other words, by compressing the spring 1, the gap 21 between the compression limiter 10 and the upper or lower circular ring formation 19 is reduced, until a contact is formed between said compression limiter 10 and the circular ring formation 19. At this point, further compression of the spring 1 will cause the compression limiter 10 to participate in bearing of the load subjected on the spring 1, effectively inhibiting further compression. Thereby, by the incorporation and dimensioning of the compression limiters 10, the load-bearing behavior of the spring 1, in other words its spring curve, may be further adjusted. The maximum amount of compression available to the spring 1 is known as its compression length reserve.

Further in the examples of FIGS. 3 and 4, the arch 12 continues at both ends as a curve 13 turning towards the upper 2 respectively the lower support surface 3. In other words, the arch 12 at each of the spring arms 11 is folded at both of its ends around the curve 13, providing an additional layer of elastically bending structure between the spring cell 5 and the support surface 2, 3 in the example of FIG. 4. In the example of FIG. 3, on the other hand, said arrangement provides a rigid structural point to the segment 4, working in conjunction with the corresponding location of the neighboring segment 4. In both said examples, a secondary section 23 of the spring arm 11 is located between the curve 13 and the support surface 2, 3, said secondary section having an orientation and structure similar to that of the arch 12 and connecting to the respective support surface 2, 3. In the example of FIG. 3, neighboring segments 4 are interconnected at the curves 13, whereas in the example of FIG. 4, the spring arms 11 extend as independent structures along their entire length.

Said interconnected structure illustrated in FIG. 3 enables the spring arms 11 to simultaneously act as compression limiters 10, each compression limiter 10 in this case forming to the location of the curve 13 of each spring arm 11 and being comprised of the adjoined spring arm sections of two neighboring segments 4. In the arrangement as described, two compression limiters 10 are facing each other at the interface between each two neighboring segments 4, the separation between said two compression limiters 10 defining the compression length reserve of the spring 1.

In the examples of FIGS. 2 to 4, the spring cell 5 at each of the segments 4 connects to the spring arms 11 at a middle section of the arch 12. With said arrangement, a symmetrical bending pattern of the segments 4 is ensured in the tangential direction of the spring 1, so as to avoid any asymmetrical deflection or buckling of the spring 1 during compression. Correspondingly, also the other parts of the spring structure according to any of the examples of FIGS. 2 to 5 are arranged into a symmetrical shape along the tangential direction of the spring.

In the example of FIG. 4, the lower support surface 3 is formed of a plurality of sectors 15 separated by a gap 16, wherein each sector 15 connects to two neighboring segments 4. With said arrangement, the stiffness of the spring 1, namely its spring curve, can be further adjusted, as well as the load transfer between the structural elements of the spring 1. In different variations of the spring 1, either one of the upper 2 and the lower support surface 3 may be formed of sectors 15 independently of each other, the sectors 15 connecting to at least one of the segments 4.

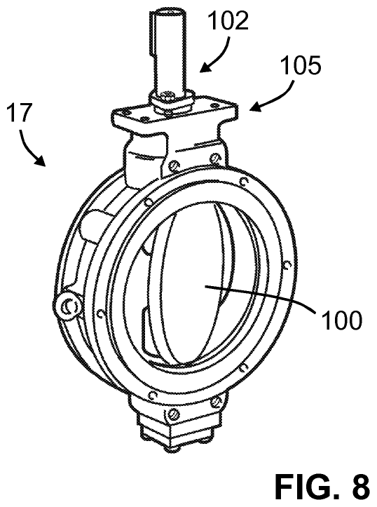

FIG. 7 illustrates a partial cross-cut section of a valve 17 provided with a sealing arrangement, the sealing arrangement comprising a spring 1. In this example, the spring 1 is a cylindrical spring 1 of a valve packing, and the spring 1 according to, for example, any one of the examples of FIGS. 2 to 5 may be used in connection with the illustrated arrangement. To better illustrate the type of application in which the sealing arrangement is used, the valve of FIG. 7 is illustrated as a whole in FIG. 8. In FIGS. 7 and 8, the valve 17 has been illustrated schematically to highlight the main components of the construction, and may have a structure deviating from said examples in other embodiments of the valve.

As seen in the examples of FIGS. 7 and 8, the valve 17 includes a closure member 100, a shaft 101 connected to it for adjusting the position of the closure member and having an end 102 protruding to an outside of the valve via a packing cavity 18. The valve 17 further includes a valve packing 103 arranged in the packing cavity 18 to surround the shaft 101, and the spring 1, which may be one according to, for example, any one of the examples of FIGS. 2 to 5, provided in the packing cavity 18 to contact the valve packing 103. The valve packing 103 may comprise, for example, packing rings used in a conventional valve packing arrangement, and provides a sealing interface to the sealing arrangement. In the example of FIG. 7, also an anti-extrusion ring 106 is provided to the packing cavity 18 as a part of the valve packing 103, said anti-extrusion ring 106 providing an additional protective layer against unbalanced extrusion or protrusion of the valve packing 103 within the packing cavity 18. The packing cavity 18 is enclosed within a valve body 105, the end 102 of the shaft 101 protruding to the outside of the valve through the valve body 105. Outside of the valve body 105, also a live-load system comprising a conventional disc spring set 104 is provided, the live-load system in said example functioning as a supplementary system to the spring 1 providing a force compressing the valve packing 103 from above through a gland 107.

The valve packing arrangement according to FIG. 7 may be provided by taking into use a valve 17 comprising the packing cavity 18 and providing the spring 1 comprising the upper support surface 2 and the lower support surface 3 into the packing cavity 18. The spring 1 may be provided together with the valve packing 103. In case the spring 1 is retrofitted to an existing valve packing arrangement of a conventional structure, some of multiple packing rings may be removed from the packing cavity 18 to accommodate the spring 1. Some or all of the previously provided structural elements, like the conventional disc spring set 104 of the live-load system, may also be retained and used in collaboration with the spring 1.

The method as disclosed is continued by applying a force to the spring 1 in a longitudinal direction of the packing cavity 18, so as to reduce the distance between the upper 2 and the lower support surface 3. By applying the compressive force to the spring 1 as described, the compression length reserve is provided to the valve sealing arrangement, said reserve enabling the sealing arrangement to accommodate for the loss of compression otherwise occurring. Said loss of compression typically takes place due to, for example, wear, temperature- and time-dependent relaxation of the structural elements of the sealing arrangement, ultimately resulting in increased emissions from the valve connection.

As a result of the structural features of the spring 1 as disclosed, the spring may be provided with a combination of high stiffness and large compression length relative to the length of the spring 1. For example, the spring 1 may be constructed so that when the method as disclosed is applied to the spring 1 having an inner diameter of approximately 45 mm, an outer diameter of approximately 60 mm and a free length of approximately 20 mm, the length of the spring, in other words the distance between the upper 2 and the lower support surface 3, may be reduced by approximately 2 to 3 mm by applying a compressive force, said compressive force generating a contact pressure of approximately 50 MPa on the packing rings. Said reduction of distance between the support surfaces 2, 3 thereby corresponds to a relatively large percentage of the uncompressed distance between said support surfaces 2, 3, said distance representing the free length of the spring 1. This way, relative compression values of approximately 15% to 20% of the spring free length may be obtained. By contrast, with a conventional sealing solution utilizing disk springs with a diameter similar to that disclosed, a free length of the spring setup up to twice as large may be needed to reach a compression length similar to that disclosed.

The spring 1 of the examples of FIGS. 2 to 5 is provided as a monolithic structure, in other words such that each of the disclosed structural elements connects seamlessly to the spring structure. Such a structure may be provided by utilizing, for example, an additive manufacturing method or a laser cutting method, wherein said structural elements are provided by cutting a preform, the preform defining the outer dimensions of the spring 1. In some embodiments of the spring 1, however, the spring 1 may also be provided as a multi-part structure. This may be accomplished by, for example, providing the segments 4 as separate structural units or as clusters between the circular ring formations 19 at the upper and lower ends of the spring 1, the circular ring formations 19 being also provided as separate structural units. In such an arrangement, also conventional rings or washers may be used at the upper and lower ends of the spring 1 to bind the segments 4.

In a monolithic structure as illustrated in FIGS. 2 to 5, any potential friction caused during compression by the relative motion between the structural elements at their contact interface is avoided, allowing for an improved force distribution over the length of the spring 1 and minimal or non-existing hysteresis in case of e.g. thermal cycling or (re-)adjustment of the live-loaded sealing system. This, in turn, has a positive influence on the sealing performance of the spring 1, as the compressive force applied to the spring is more efficiently transferred to the sealing interface of the sealing construction. Similar benefit in obtained with the spring 1 according to the invention in comparison to conventional sealing solutions comprising, for example, disk springs, wherein the elastic deflection of the disk springs during compression inevitably results in relative motion between the disk spring and the countering structural element at their contact interface, creating friction and hysteresis to their force output and spring curves. In this context, hysteresis refers to the asymmetry of the spring curve, as observed when measuring the response of the spring to loading and unloading. Said unloading may in this context be intentional unloading of the compressive force, or unintentional unloading due to, for example, wear of the sealing components.

It is to be understood that the above description and the accompanying figures are only intended to illustrate the present invention. It will be obvious to a person skilled in the art that the invention can be varied and modified without departing from the scope of the invention. The relative dimensions of the various sections of the spring 1 and the accompanying structures illustrated in FIGS. 1 to 8 may deviate from said illustrations without diverging from the spirit of the invention.

1. A valve including:
a closure member,
a shaft which is connected to the closure member for adjusting a position of the closure member and which has an end protruding to an outside of the valve via a packing cavity,
a valve packing arranged in the packing cavity to surround the shaft, and
a spring provided in the packing cavity to contact the valve packing, wherein the spring comprises:
an upper support surface,
a lower support surface,
at least two segments arranged between the upper and the lower support surface, wherein
at least one of the segments comprises a spring cell, the spring cell having an upper section connecting to the upper support surface and an opposite lower section connecting to the lower support surface, the upper section and the lower section comprising two opposite arch segments, and at least one compression limiter extending from one of the upper and the lower support surface towards the other one of the upper and the lower support surface a part of the distance between the upper and the lower support surface.

2. (canceled)

3. The valve according to claim 1, wherein at least one of the spring cells connects to at least one of the upper and the lower support surface through a spring arm.

4. The valve according to claim 3, wherein at least one spring arm extends between the upper section of the spring cell and the upper support surface, and
at least one spring arm extends between the lower section of the spring cell and the lower support surface.

5. The valve according to claim 3, wherein at least one of the spring arms is shaped as an arch curved around the cell and connecting at both ends to the upper or the lower support surface.

6. The valve according to claim 5, wherein the arch continues at both ends as a curve turning towards the upper and respectively the lower support surface.

7. The valve according to claim 5, wherein the spring cell at each of the segments connects to the at least one spring arm at a middle section of the arch.

8. The valve according to claim 1, wherein both of the upper and the lower section of the spring cell comprise two opposite arch segments, wherein each arch segment connects to the corresponding arch segment of the opposite cell section at one end, and to the upper and respectively lower support surface at another end.

9. The valve according to claim 1, wherein at least one of the upper support surface and the lower support surface is formed of a plurality of sectors separated by a gap, wherein each sector connects to at least one of the segments.

10. The valve according to claim 1, wherein the spring cell of the segments comprises four interconnected segments configured to form a closed loop which is open towards a middle axis of the spring and away from the middle axis of the spring.
